(19) United States
(12) Patent Application Publication
(10) Pub. No.: US 2026/0369211 A1
(43) Pub. Date: Nov. 19, 2026

(54) DISPLAY DEVICE AND DRIVING METHOD THEREFOR

(71) Applicant: LX Semicon Co., Ltd., Daejeon (KR)

(72) Inventor: Byeong Ho JEONG, Daejeon (KR)

(73) Assignee: LX Semicon Co., Ltd., Daejeon (KR)

(21) Appl. No.: 19/137,115

(22) PCT Filed: Dec. 8, 2023
(86) PCT No.: PCT/KR2023/020183

§ 371 Date: Jun. 9, 2025

(30) Foreign Application Priority Data
Dec. 8, 2022 (KR) 10-2022-0170420
Dec. 7, 2023 (KR) 10-2023-0176582

(51) Int. Cl. G09G 3/20; G09G 3/32

(52) U.S. Cl. CPC G09G 3/2096; G09G 3/32; G09G 2310/0245; G09G 2310/027; G09G 2310/0275; G09G 2310/0286; G09G 2310/0291; G09G 2320/0247

(57) ABSTRACT

A display device and a driving method therefor are disclosed. The display device driving method according to one embodiment comprises the steps of: receiving a scanning rate from a host system; generating a control signal for controlling whether a first chopping operation of a frame unit for an offset voltage polarity supplied to a display panel that displays an image and a second chopping operation of a pixel line for the offset voltage polarity are performed according to a result obtained by comparing the scanning rate ad a preset reference value; and outputting the control signal to a panel driving unit for driving the display panel.

### DESCRIPTION

### Technical Field

Embodiments relate to a display device and a driving method thereof.

### Background Art

In accordance with the information age, the display field that visually expresses electrical information signals has rapidly developed, and accordingly, various display devices having excellent performance are being developed.

A display device consists of a display panel, a source driver generating a driving voltage for driving a plurality of data lines, and a gate driver driving a plurality of gate lines.

In order to display an image without distortion on the display panel, it is necessary to remove offset values of output signals generated from output buffers included in the source driver. This is disclosed in Korean Registered Patent No. 10-0697287.

A display panel having a scan rate of 60 Hz or higher performed a frame-unit chopping operation chopping polarity of offset voltages of the entire screen according to the scan rate and a pixel line-unit chopping operation to remove offset values of the output signals.

However, in a low scan rate range having a scan rate of 60 Hz or lower, when performing the frame-unit chopping operation according to the low scan rate, a user can easily perceives a luminance difference due to a voltage difference, and such a difference may be perceived by the user as a flicker phenomenon.

### DISCLOSURE

### Technical Problem

Embodiments may provide a technology capable of removing a flicker phenomenon of a display panel within a scan rate range detectable by the human eye.

The object of the present invention is not limited to the object mentioned above, and other objects not mentioned will be clearly understood by those skilled in the art from the description below.

### Technical Solution

A driving method of a display device according to an embodiment includes receiving, by a timing controller, a scan rate from a host system; generating, by the timing controller, control signals which control whether to perform a first chopping operation in a frame unit for polarity of offset voltages supplied to a display panel configured to display an image and a second chopping operation in a pixel line unit for polarity of offset voltages based on a result of comparing the scan rate and a preset reference value; and outputting, by the timing controller, the control signals to a panel driver configured to drive the display panel.

The generating of the control signals may include generating the control signals which turn off the first chopping operation and keep the second chopping operation on when the scan rate is equal to or lower than the preset reference value.

The reference value may have a range of 1 Hz to 60 Hz.

The control signals may include a first control signal for controlling the first chopping operation of a source driver supplying a data voltage to the display panel, and a second control signal for controlling the second chopping operation, and the first control signal may control polarity of offset voltages in a frame unit to be maintained as either a positive voltage or a negative voltage when the scan rate is equal to or lower than the preset reference value.

The display panel may be an LTPO (Low-Temperature Polycrystalline Oxide) panel.

A display device according to an embodiment includes: a host system configured to output a scan rate; a display panel configured to display an image; a panel driver configured to drive the display panel; and a timing controller configured to control the panel driver, wherein the timing controller is configured to output control signals controlling whether to perform a first chopping operation in a frame unit for polarity of offset voltages supplied to the display panel and a second chopping operation in a pixel line unit for polarity of offset voltages based on a result of comparing the scan rate and a preset reference value.

The timing controller may be configured to output the control signals which turn off the first chopping operation and keep the second chopping operation on when the scan rate is equal to or lower than the preset reference value.

The reference value may have a range of 1 Hz to 60 Hz.

The panel driver may include a gate driver configured to supply a gate signal to the display panel; and a source driver configured to supply a data voltage to the display panel, wherein the control signals may include a first control signal for controlling the first chopping operation of the source driver and a second control signal for controlling the second chopping operation, and the first control signal may control polarity of offset voltages in a frame unit to be maintained as either a positive voltage or a negative voltage when the scan rate is equal to or lower than the preset reference value.

The display panel may be an LTPO (Low-Temperature Polycrystalline Oxide) panel.

### Effect of the Invention

The present invention, in a display having a scan rate of 60 Hz or lower detectable by the human eye, may prevent a flicker phenomenon that a user may feel when viewing the display panel 400 having a low scan rate by turning off a frame-unit chopping operation for polarity of offset voltages supplied to the display panel 400 and keeping a pixel line-unit chopping operation on.

The effects of the present invention are not limited to the effects mentioned above, and other effects not mentioned will be clearly understood by those skilled in the art from the description of the claims.

### BRIEF DESCRIPTION OF THE DRAWINGS

FIG. 1 is a block diagram schematically illustrating a display device according to an embodiment.

FIG. 2 is a block diagram schematically illustrating the source driver 310 shown in FIG. 1.

FIG. 3 is a flowchart for explaining a driving method of a display device according to an embodiment.

FIG. 4 and FIG. 5 are diagrams illustrating signal relationships when the display device operates at or above a reference value and when it operates at or below the reference value.

FIG. 6 is an example illustrating that a frame-unit chopping operation is turned off and a pixel line-unit chopping operation is maintained for the display panel 400 during one frame.

FIG. 7 is an example illustrating that a frame-unit chopping operation and a pixel line-unit chopping operation are performed for the display panel 400 during one frame.

### BEST MODE FOR CARRYING OUT THE INVENTION

Hereinafter, when explaining in detail the embodiments disclosed in this specification with reference to the attached drawings, identical or similar components will be assigned the same reference numbers regardless of their drawing reference numbers, and redundant explanations thereof will be omitted. The suffixes “module” and “part” used for components in the following description are assigned or used interchangeably only for the sake of ease in writing the specification and do not have their own distinguishing meanings or roles. Also, in explaining the embodiments disclosed in this specification, when it is determined that detailed descriptions of related known technologies may obscure the gist of the embodiments disclosed in this specification, such detailed descriptions will be omitted. Furthermore, the accompanying drawings are intended to aid in understanding the embodiments disclosed herein, and the technical ideas disclosed herein are not limited by these drawings, encompassing all modifications, equivalents, or substitutions within the spirit and technical scope of the present invention Terms containing ordinal numbers, such as first, second, and the like, may be used to describe different components, but the components are not limited by such terms. These terms are used for the sole purpose of distinguishing one component from another.

When a component is referred to as being “coupled” or “connected” to another component, it should be understood that it may be directly coupled or connected to that another component, however, there may be other components in between. Conversely, when a component is said to be “directly coupled” or “directly connected” to another component, it should be understood that there are no other components in between.

Singular expressions include plural expressions unless the context clearly indicates otherwise.

The terms such as “include” or “have”, as used herein, are intended to indicate the presence of the features, figures, steps, actions, components, parts, or any combination thereof described in the specification, however, they do not preclude the presence of or the possibility of addition of one or more other features, figures, steps, actions, components, parts, or any combination thereof.

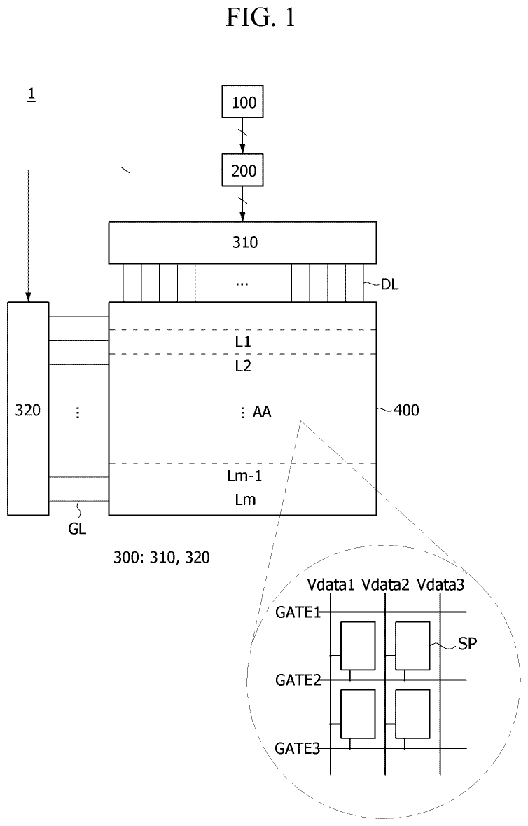

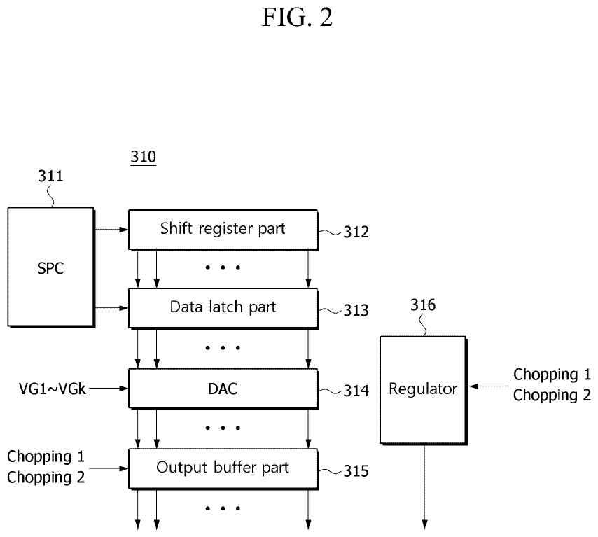

FIG. 1 is a block diagram schematically illustrating a display device according to an embodiment, and FIG. 2 is a block diagram schematically illustrating the source driver 310 shown in FIG. 1.

The display device 1 includes a host system 100, a timing controller 200, a panel driver 300, and a display panel 400.

The display device 1, in a display having a scan rate of 60 Hz or lower detectable by the human eye, may prevent a flicker phenomenon that a user may feel when viewing the display panel 400 having a low scan rate by turning off a frame-unit chopping operation for polarity of offset voltages supplied to the display panel 400 and keeping a pixel line-unit chopping operation on.

That is, the display device 1 may remove offset values by chopping polarity of offset voltages supplied to the display panel 400 in order to display an image without distortion on the display panel 400, and may remove a flicker phenomenon by turning off a frame-unit chopping operation that operates according to the scan rate among chopping operations for polarity of offset voltages when the display panel 400 operates at a scan rate equal to or lower than a certain scan rate detectable by the human eye.

The host system 100 may be any one of a TV (Television), a set-top box, a navigation system, a personal computer (PC), a home theater, a mobile system, and a wearable system. In a mobile device and a wearable device, the panel driver 300 and the timing controller 200 may be integrated into a single drive IC (not shown).

For example, in a mobile system, the host system 100 may be implemented as an AP (Application Processor). The host system 100 may transmit pixel data of an input image to the drive IC through a MIPI (Mobile Industry Processor Interface). The host system 100 may be connected to the drive IC through a flexible printed circuit, for example, an FPC (Flexible Printed Circuit).

The timing controller 200 may receive image data of an input image and driving signals synchronized with the image data from the host system 100.

The timing controller 200 may receive a scan rate from the host system 100.

The timing controller 200 may output control signals controlling whether to perform a frame-unit offset voltage chopping operation and a pixel line-unit offset voltage chopping operation for the display panel 400 in response to the scan rate.

For example, the pixel line unit may vary depending on a pixel configuration of the display panel 400. For example, in a case where the pixel configuration of the display panel 400 is a panel configured by chopping a line where RGBG (Red, Green, Blue, Green) is repeated and a line where BGRG (Blue, Green, Red, Green) is repeated, the line where RGBG is repeated and the line where BGRG is repeated may be defined as one line unit.

That is, the operation of the pixel line-unit offset voltage chopping may be performed line by line during one horizontal period (1H).

For example, the control signals may include a first control signal (Chopping 1) for controlling a frame-unit offset voltage chopping operation of the source driver 310, and a second control signal (Chopping 2) for controlling a line-unit offset voltage chopping operation.

For example, the first control signal (Chopping 1) may control polarity of offset voltages in a frame unit to be maintained as either a positive voltage or a negative voltage when the scan rate is equal to or lower than a preset reference value.

For another example, the first control signal (Chopping 1) may include a vertical synchronization signal Vsync, a horizontal synchronization signal Hsync, a clock signal DCLK, and a data enable signal DE, etc. The second control signal (Chopping 2) may include a start pulse (Gate Start Pulse, VST) and a shift clock GCLK, etc.

For example, the timing controller 200 may output a control signal that turns off a frame-unit offset voltage chopping operation when the scan rate is equal to or lower than a preset reference value. That is, turning off may mean controlling polarity of offset voltages in a frame unit to be maintained as either a positive voltage or a negative voltage.

For example, the range of the preset reference value may be 1 Hz to 60 Hz, and may be set to a range or a specific scan rate capable of removing a flicker phenomenon detectable by the human eye due to a luminance difference caused by a voltage difference of the display panel 400 at a low scan rate. For example, the reference value may be set to 1 Hz.

The panel driver 300 may drive the display panel 400.

The panel driver 300 may include a source driver 310 and a gate driver 320.

The source driver 310 may output signals corresponding to image data to the display panel 400 through data lines DL in response to the image data and a horizontal synchronization signal HSYNC output from the timing controller 200.

The source driver 310 may include a plurality of amplifiers (not shown) for outputting output signals corresponding to image data.

The source driver 310 may be implemented to remove an offset of the amplifiers by performing a chopping operation using AODC (amplifier offset dependent chopping).

The source driver 310 uses a spatial offset removal method or a temporal offset removal method through a chopping operation.

The source driver 310 converts pixel data of an input image received as a digital signal from the timing controller 200 for each frame into an analog gamma-compensated voltage using a DAC 314 to output data signals Vdatal to Vdata3. The data signals Vdatal to Vdata3 may be supplied to the data lines DL.

The source driver 310 may include a serial-parallel converter 311, a shift register part 312, a data latch part 313, a DAC (Digital to Analog Converter) 314, an output buffer part 315, and a regulator 316.

The serial-parallel converter (SPC) 311 may receive at least one clock and RGB data in a serialized low voltage differential signaling method and convert them into parallel RGB data.

The shift register part 312 receives a clock from the serial-parallel converter 311 and sequentially shift it. Here, the clock may be used to synchronize an output of the shift register part 312.

The data latch part 313 includes a plurality of latch circuits (not shown). Each of the latch circuits may receive clocks output from the shift register part 312 and parallelized RGB data output from the serial-parallel converter 311. That is, the data latch part 313 may sequentially store the parallelized RGB data from one end to the other end of the latch circuits based on the shifted clocks.

The DAC (Digital to Analog Converter) 314 may convert parallelized RGB data (data corresponding to one pixel line) stored in the data latch part 313 into analog data using gamma reference voltages VG1 to VGk (k is a natural number).

The output buffer part 315 may include a plurality of output buffers (not shown). Each of the plurality of output buffers may output analog data converted by the DAC 314 to a corresponding pixel.

The regulator 316 may output a voltage necessary for pixel driving to the display panel 400. For example, the regulator 316 may output a reference voltage Vref and/or an initialization voltage Vinit for pixel driving of the display panel 400.

At least one of the output buffer part 315 and the regulator 316 may perform a frame-unit chopping operation for polarity of offset voltages of the display panel 400 in response to the first control signal (Chopping 1) from the timing controller 200.

At least one of the output buffer part 315 and the regulator 316 may perform a pixel line-unit chopping operation for polarity of offset voltages in response to the second control signal (Chopping 2) from the timing controller 200.

That is, at least one of the output buffer part 315 and the regulator 316 may chop polarity of offset voltages of the display panel 400 in a frame unit or a pixel line unit from a positive voltage high (+) to a negative voltage low (−), or from low (−) to high (+) in response to control signals (Chopping 1, Chopping 2).

For example, at least one of the output buffer part 315 and the regulator 316 may chop polarity of offset voltages in a frame unit from a positive voltage high (+) to a negative voltage low (−), or from low (−) to high (+) in response to the first control signal (Chopping 1), or may maintain a positive voltage high or a negative voltage low. At least one of the output buffer part 315 and the regulator 316 may chop polarity of offset voltages in a pixel line unit from a positive voltage high (+) to a negative voltage low (−), or from low (−) to high (+) in response to the second control signal (Chopping 2).

At least one of the output buffer part 315 and the regulator 316 may include an operational amplifier (not shown), and may remove a frame-unit offset, which is a temporal offset, and a pixel line-unit offset, which is a spatial offset, of the operational amplifier (not shown) by performing a chopping operation.

The gate driver 320 receives a gate timing control signal, outputs gate signals GATE1 to GATE3 synchronized with data signals Vdatal to Vdata3, and supplies them to pixel lines GL. The gate signals GATE1 to GATE3 applied to the pixel lines GL turn on switch elements of sub-pixels SP to select a pixel line where voltages of the data signals Vdatal to Vdata3 are charged.

The display panel 400 may display an image.

The display panel 400 may perform a chopping operation in a frame unit or a pixel line unit according to polarity of offset voltages from the regulator 316 of the source driver 310.

The display panel 400 may prevent a flicker phenomenon recognizable by a user during a low scan rate operation by the timing controller 200 turning off a frame-unit chopping operation and keeping a line-unit chopping operation on in response to a reference value (for example, a scan rate of 60 Hz or lower).

The display panel 400 may be implemented as an LTPO (Low-Temperature Polycrystalline Oxide) panel.

For example, when a display panel 400 is implemented as an LTPO panel, a pixel line-unit chopping operation operates in a sufficiently short period that is not recognizable by the human eye as an interval between lines even if the scan rate is 1 Hz, and thus, a user does not feel a flicker phenomenon, whereas a frame unit chopping operation chops at the same rate as the scan rate, and thus, the user may feel a flicker phenomenon. However, in the present invention, when operating at or below a preset reference value (for example, a scan rate of 60 Hz or less), a flicker phenomenon may be eliminated by turning off a frame unit chopping operation.

The display panel 400 may include a pixel array AA that displays pixel data of an input image on a screen.

The pixel array AA includes a plurality of data lines DL, a plurality of pixel lines GL intersecting with the data lines DL, and pixels arranged in a matrix form. The arrangement form of the pixels may be variously formed, such as a form sharing pixels emitting the same color, a stripe form, or a diamond form, in addition to a matrix form.

When a resolution of the pixel array AA is n*m, the pixel array AA includes n pixel columns and m pixel lines L1-Lm intersecting with the pixel columns. The pixel columns include pixels arranged along a y-axis direction. The pixel lines include pixels arranged along an x-axis direction.

One horizontal period (1H) is a time obtained by dividing one frame period by the number of m pixel lines L1 to Lm. Pixel data may be written to pixels of one pixel line in one horizontal period (1H). For example, one pixel line may mean a line where a data voltage is simultaneously applied in one horizontal period (1H).

Each of the pixels may be divided into a red sub-pixel (Red), a green sub-pixel (Green), and a blue sub-pixel (Blue) for color implementation. Each of the pixels may further include a white sub-pixel.

Each of the sub-pixels SP includes a pixel circuit. The pixel circuit includes a pixel electrode, a plurality of TFTs (Thin Film Transistors), and a capacitor. The pixel circuit may be connected to a data line DL and a pixel line GL.

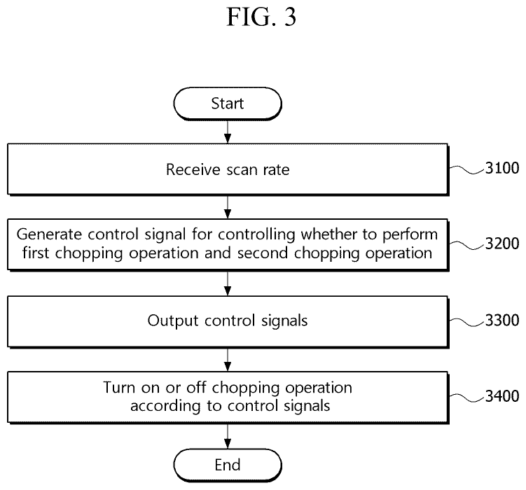

FIG. 3 is a flowchart for explaining a driving method of a display device according to an embodiment.

The timing controller 200 may receive a scan rate from the host system 100 (3100).

The timing controller 200 may generate a control signal for controlling whether to perform a first chopping operation in a frame unit for polarity of offset voltages supplied to the display panel 400 displaying an image and a second chopping operation in a pixel line unit for polarity of offset voltages based on a result of comparing the scan rate and a preset reference value (3200).

For example, the timing controller 200 may generate control signals for controlling an operation of the source driver 310 to turn off the first chopping operation and keep the second chopping operation on when the scan rate is equal to or lower than the preset reference value.

For example, the reference value may have a range of 1 Hz to 60 Hz.

For example, the control signals may include a first control signal for controlling the first chopping operation and a second control signal for controlling the second chopping operation of the source driver 310.

For example, the source driver 310 may perform a frame-unit chopping operation for polarity of offset voltages of the display panel 400 in response to the first control signal (Chopping 1) from the timing controller 200.

The source driver 310 may perform a pixel line-unit chopping operation for polarity of offset voltages in response to the second control signal (Chopping 2) from the timing controller 200.

That is, the source driver 310 may chop polarity of offset voltages of the display panel 400 in a frame unit or a pixel line unit from a positive voltage high (+) to a negative voltage low (−), or from low (−) to high (+) in response to control signals (Chopping 1, Chopping 2).

For example, the source driver 310 may chop polarity of offset voltages in a frame unit from a positive voltage high (+) to a negative voltage low (−), or from low (−) to high (+) in response to a first control signal (Chopping 1), or may maintain a positive voltage high or a negative voltage low. The source driver 310 may chop polarity of offset voltages in a pixel line unit from a positive voltage high (+) to a negative voltage low (−), or from low (−) to high (+) in response to a second control signal (Chopping 2).

The timing controller 200 may generate the first control signal (Chopping 1) for controlling the first chopping operation of the source driver 310, and the second control signal (Chopping 2) for controlling the second chopping operation. For example, the first control signal (Chopping 1) may control polarity of offset voltages in a frame unit to be maintained as either a positive voltage or a negative voltage when the scan rate is equal to or lower than a preset reference value.

The timing controller 200 may output the control signals to the panel driver 300 driving the display panel 400 (3300).

In the panel driver 300, the source driver 310 may turn on or off the chopping operation for polarity of offset voltages of the display panel 400 according to the control signals (3400).

For example, in the panel driver 300, the source driver 310 may perform a frame-unit chopping operation for polarity of offset voltages of the display panel 400 in response to the first control signal (Chopping 1). The source driver 310 may perform a pixel line-unit chopping operation for polarity of offset voltages in response to the second control signal (Chopping 2).

For example, the panel driver 300 may turn off the first chopping operation for polarity of offset voltages in a frame unit and keep the second chopping operation for polarity of offset voltages in a pixel line unit on in response to each signal when the first control signal (Chopping 1) is a signal that turns off the first chopping operation and the second control signal (Chopping 2) is a signal that keeps the second chopping operation on.

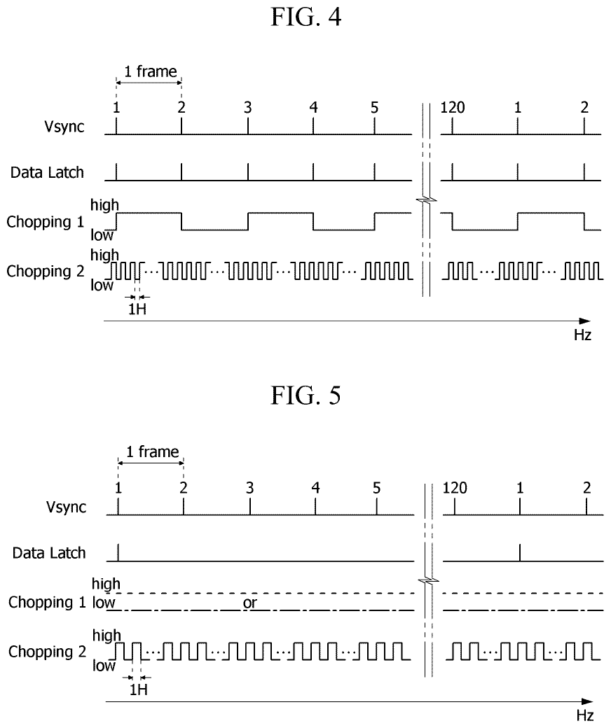

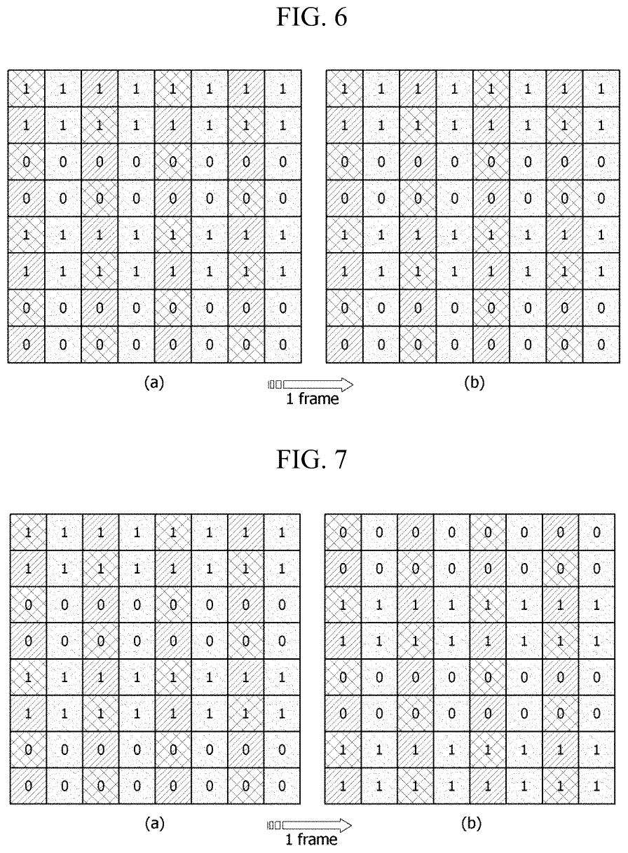

FIG. 4 and FIG. 5 are diagrams illustrating signal relationships when the display device operates at or above the reference value and when it operates at or below the reference value, FIG. 6 is an example illustrating that the frame-unit chopping operation is turned off and the pixel line-unit chopping operation is maintained for the display panel during one frame, and FIG. 7 is an example illustrating that the frame-unit chopping operation and the pixel line-unit chopping operation are performed for the display panel during one frame.

FIG. 4 schematically illustrates an example where the scan rate received by the timing controller 200 from the host system 100 is equal to or higher than the reference value or exceeds it, and may illustrate a period of a vertical synchronization signal Vsync, a latch signal Data Latch, the first control signal (Chopping 1) which is a frame-unit first chopping operation signal, and the second control signal (Chopping 2) which is a pixel line-unit second chopping operation signal when the scan rate is 120 Hz.

When the scan rate received from the host system 100 is a scan rate of 120 Hz, the timing controller 200 may output the first control signal (Chopping 1) to perform a frame-unit offset voltage chopping operation for the display panel 400 every 1/120 second, and may output the second control signal (Chopping 2) to perform a line-unit offset voltage chopping operation every one horizontal period (1H).

That is, when the scan rate is a scan rate of 120 Hz, a user cannot recognize the frame chopping operation, and thus cannot feel a flicker phenomenon.

FIG. 5 schematically illustrates an example within the reference value range, and may illustrate a period of the vertical synchronization signal Vsync, the latch signal (Data Latch), the first control signal (Chopping 1) which is a frame-unit first chopping operation signal, and the second control signal (Chopping 2) which is a pixel line-unit second chopping operation signal when the scan rate received from the host system 100 is a scan rate of 1 Hz.

When the scan rate received from the host system 100 is a scan rate of 1 Hz which is equal to or lower than the reference value, the timing controller 200 may output the first control signal (Chopping 1) to turn off a frame-unit offset voltage chopping operation for the display panel 400 by maintaining a positive voltage high or a negative voltage low, and may output the second control signal (Chopping 2) to perform a pixel line-unit offset voltage chopping operation every one horizontal period (1H).

FIG. 6 is a diagram illustrating polarity of offset voltages of sub-pixels of the display panel 400 as 1 and 0, and 1 may mean a positive voltage, and 0 may mean a negative voltage.

(a) in FIG. 6 illustrates polarity of offset voltages of sub-pixels in a first frame, and (b) in FIG. 6 may illustrate polarity of offset voltages in a second frame which is a subsequent frame period of the first frame.

The timing controller 200 may turn off a first chopping operation in a frame unit for polarity of offset voltages supplied to the display panel 400 and keep a second chopping operation in a pixel line unit for polarity of offset voltages on when a scan rate is equal to or lower than a preset reference value.

That is, when a scan rate is equal to or lower than a preset reference value, a frame-unit chopping operation for the display panel 400 during one frame period from (a) in FIG. 6 to (b) in FIG. 6 is turned off by maintaining polarity of offset voltages in a frame unit as either a positive voltage or a negative voltage, and a pixel line-unit chopping operation for the display panel 400 may be performed every one horizontal period (1H).

FIG. 7 is a diagram illustrating polarity of offset voltages of sub-pixels of the display panel 400 as 1 and 0, and 1 may mean a positive voltage, and 0 may mean a negative voltage.

(a) in FIG. 7 illustrates polarity of offset voltages of sub-pixels in a third frame, and (b) in FIG. 7 may illustrate polarity of offset voltages in a fourth frame which is a next frame period of the third frame.

The timing controller 200 may keep a first chopping operation in a frame unit for polarity of offset voltages supplied to the display panel 400 and a second chopping operation in a pixel line unit for polarity of offset voltages on when a scan rate exceeds or is equal to a preset reference value.

That is, when a scan rate exceeds or is equal to a preset reference value, a frame-unit chopping operation for the display panel 400 during one frame period from (a) in FIG. 7 to (b) in FIG. 7 is performed every one frame, and a pixel line-unit chopping operation for the display panel 400 may be performed every one horizontal period (1H).

For example, when a scan rate is equal to or lower than a preset reference value, if a frame-unit chopping operation for the display panel 400 during one frame period is performed every one frame, a user may feel it as a flicker phenomenon.

The display device 1, in a display having a scan rate of 60 Hz or lower detectable by the human eye, may prevent a flicker phenomenon that a user may feel when viewing the display panel 400 having a low scan rate by turning off a frame-unit chopping operation for polarity of offset voltages supplied to the display panel 400 and keeping a pixel line-unit chopping operation on.

Although the embodiments of the present invention have been described in more detail with reference to the accompanying drawings, they are not necessarily limited to such embodiments, and may be modified in various ways within its scope without departing from the technical spirit of the present invention. Therefore, the embodiments disclosed in the present specification are provided for illustrative purposes only and do not intended to limit the technical concept of the present invention, and the scope of the technical concept of the present invention is not limited to these embodiments. Therefore, it should be understood that the embodiments described above are illustrative in all aspects and do not limit the present invention. The scope of protection of the present invention should be construed on the basis of the following claims, and all technical concepts within the equivalent scope thereof should be construed as falling within the scope of the present invention.

1. A driving method of a display device, comprising:
receiving, by a timing controller, a scan rate from a host system;
generating, by the timing controller, control signals which control whether to perform a first chopping operation in a frame unit for polarity of offset voltages supplied to a display panel configured to display an image and a second chopping operation in a pixel line unit for polarity of offset voltages based on a result of comparing the scan rate and a preset reference value; and
outputting, by the timing controller, the control signals to a panel driver configured to drive the display panel.

2. The driving method of a display device according to claim 1, wherein the generating of the control signals includes generating the control signals which turn off the first chopping operation and keep the second chopping operation on when the scan rate is equal to or lower than the preset reference value.

3. The driving method of a display device according to claim 2, wherein the reference value has a range of 1 Hz to 60 Hz.

4. The driving method of a display device according to claim 3, wherein the control signals include a first control signal for controlling the first chopping operation of a source driver supplying a data voltage to the display panel, and a second control signal for controlling the second chopping operation, and the first control signal controls polarity of offset voltages in a frame unit to be maintained as either a positive voltage or a negative voltage when the scan rate is equal to or lower than the preset reference value.

5. The driving method of a display device according to claim 4, wherein the display panel is an LTPO (Low-Temperature Polycrystalline Oxide) panel.

6. A display device, comprising:
a host system configured to output a scan rate;
a display panel configured to display an image;
a panel driver configured to drive the display panel; and
a timing controller configured to control the panel driver,
wherein the timing controller is configured to output control signals controlling whether to perform a first chopping operation in a frame unit for polarity of offset voltages supplied to the display panel and a second chopping operation in a pixel line unit for polarity of offset voltages based on a result of comparing the scan rate and a preset reference value.

7. The display device according to claim 6, wherein the timing controller is configured to output the control signals which turn off the first chopping operation and keep the second chopping operation on when the scan rate is equal to or lower than the preset reference value.

8. The display device according to claim 7, wherein the reference value has a range of 1 Hz to 60 Hz.

9. The display device according to claim 8, wherein the panel driver includes:
a gate driver configured to supply a gate signal to the display panel; and
a source driver configured to supply a data voltage to the display panel,
wherein the control signals include a first control signal for controlling the first chopping operation of the source driver and a second control signal for controlling the second chopping operation, and the first control signal controls polarity of offset voltages in a frame unit to be maintained as either a positive voltage or a negative voltage when the scan rate is equal to or lower than the preset reference value.

10. The display device according to claim 9, wherein the display panel is an LTPO (Low-Temperature Polycrystalline Oxide) panel.
